(19) United States
(12) Patent Application Publication
(10) Pub. No.: US 2015/0132556 A1
(43) Pub. Date: May 14, 2015

(54) Flame Retardant Acoustical Fiber Product

(71) Applicant: Barry Wyerman, Novi, MI (US)

(72) Inventor: Barry Wyerman, Novi, MI (US)

(21) Appl. No.: 13/547,652

(22) Filed: Jul. 12, 2012

(51) Int. Cl. B32B 5/02; B32B 7/12; B32B 5/30; B32B 5/24; B32B 5/16

(52) U.S. Cl. CPC B32B 5/022; B32B 5/24; B32B 5/16; B32B 5/30; B32B 7/12; B32B 2250/03; B32B 2250/24; B32B 2255/02; B32B 2255/26; B32B 2305/20; B32B 2307/102; B32B 2307/3065; B32B 2307/56; B32B 2262/0284; B32B 2262/062; B32B 2262/14; B32B 2262/12; B32B 2272/00; B32B 2605/00
USPC 428/215; 442/361; 181/294

(57) ABSTRACT

The present invention includes a moldable, flame retardant acoustical fiber system including a nonwoven, moldable layer of a blend of fibers, with a flame retardant coating applied on both top and bottom sides of the moldable layer. The system also includes a spun bond nonwoven black surface adhered to the flame retardant coating on one side of the nonwoven layer. The moldable, flame retardant acoustical fiber system is configured to meet the UL 94 V-0 flame test standard.

### FIELD OF THE INVENTION

This invention relates to molded structural parts. More specifically, the invention relates to a flame retardant fiber product for acoustical absorption that can be molded into various shapes for use under a valve cover in an engine of a vehicle.

### SUMMARY

The invention describes a flame retardant fiber product used for acoustical absorption under a valve cover in the engine of an automobile. The product meets the very stringent UL 94 V-0 flame test and provides high acoustical absorption to reduce noise from the engine and the valve assembly. The product is a needled nonwoven from one or more special fiber blends. Depending on the fiber blend, the nonwoven pad can be coated on each side with a special flame retardant material to provide non burning properties. The product also includes a spun bond nonwoven black surface that is adhered to one side of the nonwoven pad for decorative purposes with an adhesive, for example, a phenolic resin adhesive. The entire construction can be formed into a three dimensional product shape through a thermoplastic molding operation using hot and/or cold molds. The product can then be trimmed to a preferred outline and shape with water jet or standard trim tools.

### BRIEF DESCRIPTION OF THE DRAWINGS

The accompanying drawings, which are incorporated in and constitute a part of this specification, illustrate embodiments of the invention. The invention will be best understood by reading the ensuing specification in conjunction with the drawings, in which same numbered elements are identical.

Embodiments will hereinafter be described in detail below with reference to the accompanying drawings, wherein like reference numerals represent like elements. The accompanying drawings have not necessarily been drawn to scale. For example, tilt angles and feature sizes may be exaggerated in the figures. Where applicable, some features may not be illustrated to assist in the description of underlying features.

FIG. 1 is a cross-sectional, side view of a moldable, flame retardant acoustically absorbing fiber system, in accordance with one or more embodiments of the present invention.

FIG. 2 is a cross-sectional, side view of a moldable, flame retardant acoustically absorbing fiber system, in accordance with one or more other embodiments of the present invention.

FIG. 3 is a cross-sectional, side view of a moldable, flame retardant acoustically absorbing fiber system, in accordance with further embodiments of the present invention.

FIG. 4 is a side view of a moldable, flame retardant acoustically absorbing fiber system, in accordance with yet other embodiments of the present invention.

FIG. 5 is a cross-sectional, side view of a moldable, flame retardant acoustically absorbing fiber system, in accordance with still other embodiments of the present invention.

### DETAILED DESCRIPTION

In the following detailed description, numerous specific details are set forth in order to provide a thorough understanding of the disclosed subject matter. However, it will be understood by those of ordinary skill in the art that the present invention may be practiced without these specific details. In other instances, well-known methods, procedures and components may not have been described in detail so as not to obscure aspects of the disclosed subject matter.

Embodiments of the present invention are directed generally to a flame retardant fiber product used for acoustical absorption under a valve cover in the engine of an automobile. The final product meets the very stringent UL 94 V-0 flame test standard from UL LLC of Camas, Wash., which is hereby incorporated herein in its entirety, and provides high acoustical absorption to reduce noise from the engine and the valve assembly. The product is a needled nonwoven fabric pad made from special fiber blends made using low cost, recycled fibers, which have inherent and/or provided flame retardant characteristics. In some embodiments, the nonwoven fabric pad is coated on each side with a special flame retardant material to provide additional non-burning properties. The product also includes a spun bond nonwoven black surface that is adhered to one side of the nonwoven pad for decorative purposes. In general, this is done using a phenolic resin adhesive. The entire construction can be formed into a three dimensional product shape through a thermoplastic molding operation and cold molds. The product can then be trimmed to a preferred outline and shape with a water jet or standard trim tools. As used herein, the phrase “various embodiments” is intended to mean an embodiment, at least one embodiment, some embodiments, and/or all embodiments without limitation.

In various embodiments of the present invention, the fiber blend of the flame retardant fiber product consists of three (3) components. In some embodiments, the first component is a low cost, recycled mix including mostly Aramid fibers from the cuttings of fire-proof/flame retardant protective clothing for emergency service personnel and fire fighters and a small percentage of waste cotton fiber. The second component is a low temperature polyethylene terephthalate (PET) bi-component binder fiber that is used to mold the product to a three dimensional shape required for each application. The third component is a high temperature PET bi-component binder fiber that is also used to mold the product to the three dimensional shape required in each application and to impart dimensional stability at temperatures above the softening point of the low temp PET bi-component fiber. The flame retardant coating is a generally available commercially flame retardant such as, for example, one used in the textile industry for flame proofing clothing and more specifically one used for flame proofing children's pajamas.

The flame retardant coating can be applied with a roll coater at a prescribed add-on weight of about 5% to 15%, depending on the specific mixture of fibers used in each embodiment, to meet the UL 94 V-0 test requirements. The black surface is spun bond polyester that is commercially available.

Generally, the Aramid fibers have good flame retardant properties; however, the PET binder fibers that are added to the blend for molding purposes are a fuel source that can cause the fiber insulator to burn when exposed to a flame. The flame retardant coating provides a protective coating to the outside surface of the nonwoven, moldable layer and acts as an oxygen scavenger because it depletes oxygen during the burning process to slow the burning. If too little of the flame retardant coating is applied, it will not coat the burnable fibers and the final product will fail the UL 94 V-0 test. In addition, too much of the flame retardant coating destroys the acoustical performance of the product by altering its porosity and increases the overall weight and cost of the product.

In embodiments of the present invention, the fiber layer design of the product uses low cost, recycled fine denier fibers for acoustical absorption at low weight. The black surface is acoustically transparent so that the sound absorption of the fiber layer beneath this surface is not compromised and possibly has favorable air flow properties to further enhance and improve sound absorption.

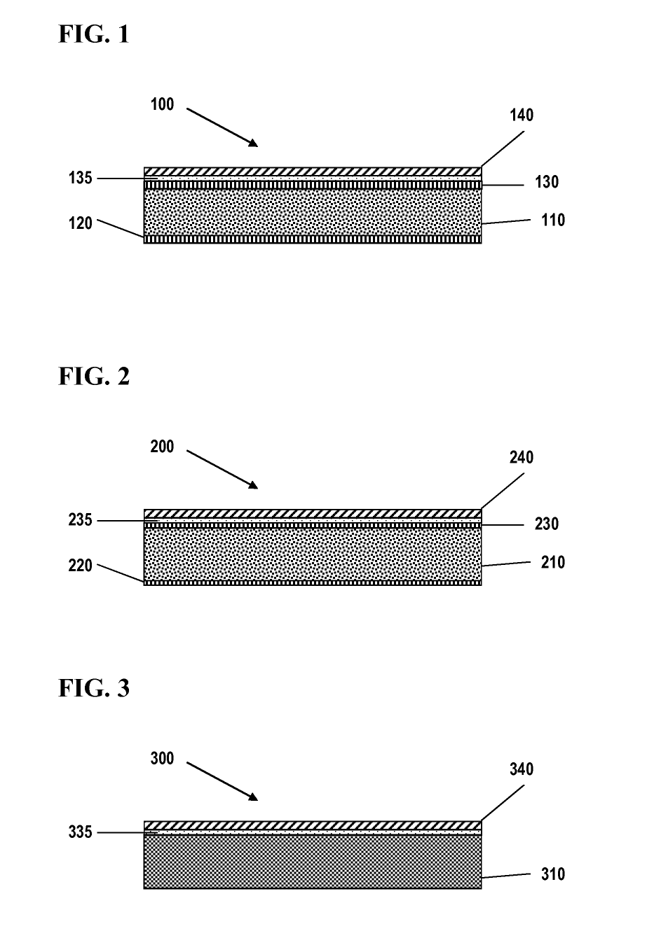

FIG. 1 is a cross-sectional, side view of a moldable, flame retardant acoustically absorbing fiber system, in accordance with one or more embodiments of the present invention. In FIG. 1, a moldable, flame retardant acoustically absorbing fiber system 100 is shown to include a nonwoven, moldable layer of a blend of low cost, recycled fibers, including a needled layer of 110 of a mixture of fibers including mainly about 50% low cost, recycled fibers from fire proof/flame retardant protective clothing for emergency service personnel and fire fighters, about 25% low temperature PET bi-component binder fibers (i.e., fibers having an activation temperature of about 110 degrees C.), and about 25% high temperature PET bi-component binder fibers (i.e., fibers having an activation temperature of about 180 degrees C.). In general, the needled layer 110 has a weight of about 700 grams/m², an unmolded thickness of about 12 to 15 mm and a final molded thickness of about 6 mm. In the embodiment in FIG. 1, as well as all other embodiments disclosed and claimed herein, the weight of the fibers in the needled layer 110 are selected to achieve an optimal balance between stiffness and sound absorption in the final molded product. Applied to a first side of an unmolded, needled layer 110 is a first flame retardant coating 120, and applied to a second side of the unmolded, needled layer 110 is a second flame retardant coating 130. Each flame retardant coating 120, 130 penetrates about 2 to 3 mm into the unmolded, needled layer 110. A spun bond nonwoven black surface 140 is adhered to one side of the needled layer 110 with the flame retardant coating (e.g., the second flame retardant coating 130). The black surface 140 is water and oil resistant, acoustically transparent and can be adhered to the needled layer 110 and the second flame retardant coating 130 with a heat activated powdered adhesive 135, for example, a heat activated phenolic adhesive resin. The black surface 140 can be, for example, but not limited to, spun bond polyester number Zetafelt G92/4298/70 K82 from Hof Textiles of Lincolnton, N.C. In general, the black surface 140 has a weight of about 85 to 90 grams/m² and a finished thickness of about 1 mm.

In FIG. 1, the first and second flame retardant layers 120, 130 together can add about 15% by weight of the weight of the needled layer 110 or about 105 grams/m² and are substantially equal to each other in weight and depth of penetration into the needle layer 110. Therefore, the total weight of the fiber system embodiment in FIG. 1 is about 895 grams/m². The flame retardant coatings 120, 130 generally are applied one at a time using a roll coating process and then dried in an oven. Once both flame retardant layers 120, 130 are dried the black surface 140 can be adhered to the side of the needled layer 110 with the second flame retardant coating 130. The black surface 140 is considered the finished surface, so when the fiber system 100 is installed inside an engine valve cover, the black surface 140 is visible and faces the engine. The flame retardant coatings 120, 130 provide the non-burning properties so the entire system meets the UL 94 V-0 flame test and can be made of, for example, StarTex™ FR PE Conc. from StarChem of Wellford, S.C.

Molding of the product in FIG. 1 can be done by preheating sheet sections of the final product fiber system 100 to above the activation temperatures for the PET bi-component binder fibers and then molding the final shape using cold metal molds. Alternatively, sheet sections of the final product fiber system 100 can be heated to above the activation temperatures and then cooled in the same mold.

FIG. 2 a cross-sectional, side view of a moldable, flame retardant acoustically absorbing fiber system, in accordance with another embodiment of the present invention. In FIG. 2, a moldable, flame retardant acoustically absorbing fiber system 200 is shown to include a nonwoven, moldable layer of a blend of fibers, including a needled layer of 210 of a mixture of fibers including mainly about 60 to 90% recycled fibers from fire proof/flame retardant protective clothing for emergency service personnel and fire fighters, about 5 to 20% low temperature PET bi-component binder fibers, and about 5 to 20% high temperature PET bi-component binder fibers. The activation temperatures of the binder fibers are the same as described above for FIG. 1. In general, the needled layer 210 in FIG. 2 has a weight of about 700 grams/m², an unmolded thickness of about 12 to 15 mm and a molded thickness of about 6 mm. The lower amount of each PET bi-component binder fiber reduces the overall stiffness of the product and reduces the amount of additional flame retardant that is needed for the product to meet the requirements of the UL 94 V-0 flame test. Applied to a first side of the needled layer 210 is a first flame retardant coating 220, and applied to a second side of the needled layer 210 is a second flame retardant coating 230. Each flame retardant coating 220, 230 penetrates about 2 to 3 mm into the unmolded, needled layer 210. A spun bond nonwoven black surface 240 is adhered to one side of the needled layer 210 with the flame retardant coating (e.g., the second flame retardant coating 230). The black surface 240 is water and oil resistant, acoustically transparent and can be adhered to the needled layer 210 and the second flame retardant coating 230 with a heat activated powdered adhesive 235, for example, a heat activated phenolic adhesive resin. The black surface 240 can be, for example, but not limited to, spun bond polyester number Zetafelt G92/4298/70 K82 from Hof Textiles of Lincolnton, N.C. In general, the black surface 240 has a weight of about 85 to 90 grams/m² and a finished thickness of about 1 mm.

In FIG. 2, the first and second flame retardant coatings 220, 230 together can add up to about 10% by weight of the weight of the needled layer 110 and are substantially equal to each other in weight and depth of penetration into the needle layer 110. If no flame retardant coating is used, then the structure of the product is similar to that illustrated in FIG. 3. For example, if the weight of the needled layer is 700 grams/m², the flame retardant coatings 220, 230 add up to 10%, then the combined weight of the flame retardant layers ranges from 0 to about 70 grams/m², and the total weight of the fiber system 100 ranges from about 785 to 860 grams/m². The flame retardant layers 220, 230 generally are applied one at a time using a roll coating process and then dried in an oven. Once both layers are dried the black layer 240 can be adhered to the second flame retardant layer 230. Each flame retardant layer 220, 230 meets the UL 94 V-0 flame test and can be made of, for example, StarTex™ FR PE Conc. from StarChem of Wellford, S.C.

Molding of the fiber system 200 into its final product shape can be done using the equipment and method described above for the fiber system 100 in FIG. 1.

FIG. 3 is a cross-sectional, side view of a moldable, flame retardant acoustically absorbing fiber system, in accordance with one or more other embodiments of the present invention. In FIG. 3, a moldable, flame retardant acoustically absorbing fiber system 300 is shown to include a nonwoven, moldable layer of a blend of fibers, including a needled layer of a mixture of fibers 310 including mainly about 50 to 90% generic shoddy-blend low cost, recycled fibers (e.g., all cotton fibers, all polyester, all nylon or other synthetic fibers or a mixture thereof) that have been saturated with a fire retardant chemical, about 5 to 25% low temperature PET bi-component binder fibers, and about 5 to 25% high temperature PET bi-component binder fibers. The lower amount of each PET bi-component binder fiber reduces the overall stiffness of the product and reduces the amount of additional flame retardant that is needed for the product to meet the requirements of the UL 94 V-0 flame test. The activation temperatures of the binder fibers are the same as described above for FIG. 1. In general, the needled layer 310 in FIG. 3 has a weight of about 700 grams/m², an unmolded thickness of about 12 to 15 mm and a molded thickness of about 6 mm.

Although not shown in FIG. 3, a first flame retardant coating can be applied to a first side of the needled layer 310 and a second flame retardant coating can be applied to a second side of the needled layer 310, which has a structure similar to that illustrated in FIGS. 1 and 2. If applied, each flame retardant coating penetrates about 2 to 3 mm into the unmolded, needled layer 310. Adhered to a first side of the needled layer 310 is a spun bond nonwoven black surface 340. Prior to forming the needled layer 310 the shoddy-blend fibers are completely saturated in a bath of ammonium sulfate and then dried before they are mixed with the low and high temperature PET bi-component binder fibers, which have also been dipped in the ammonium sulfate and dried before being mixed. The black surface 340 is considered the finished surface, so when the fiber system 300 is installed inside an engine valve cover, the black surface 340 is visible and faces the engine. The black surface 340 is water and oil resistant, acoustically transparent and can be adhered to the needled layer 310 with a heat activated powdered adhesive 335, for example, a heat activated phenolic adhesive resin. The black surface 340 can be, for example, but not limited to, spun bond polyester number Zetafelt G92/4298/70 K82 from Hof Textiles of Lincolnton, N.C. In general, the black surface 340 has a weight of about 85 to 90 grams/m² and a finished thickness of about 1 mm.

In FIG. 3, the first and second flame retardant coatings together can add up to about 15% by weight of the weight of the needled layer 310 and are substantially equal to each other in weight and depth of penetration into the needle layer 310. For example, if the weight of the needled layer is 700 grams/m², the flame retardant coatings add up to 15%, then the combined weight of the flame retardant layers ranges from 0 to about 105 grams/m², and the total weight of the fiber system 100 ranges from about 785 to 895 grams/m².

Molding of the fiber system 300 into its final product shape can be done using the equipment and method described above for the fiber system 100 of FIG. 1.

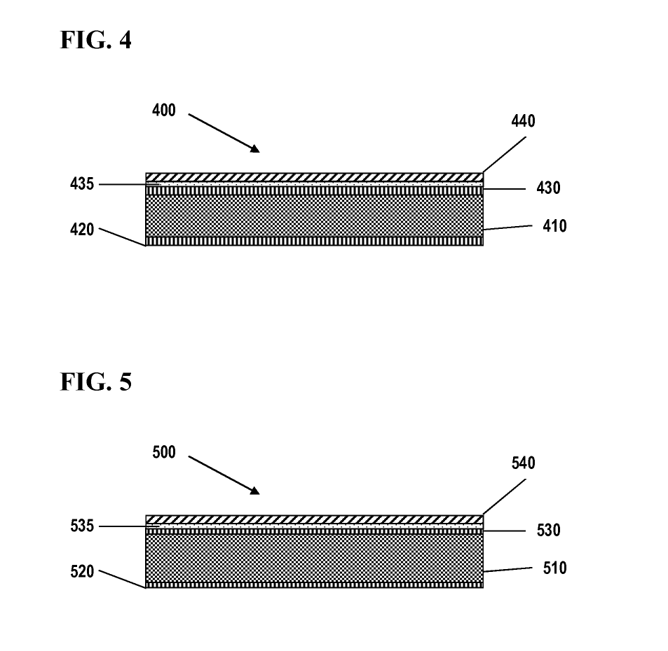

FIG. 4 is a cross-sectional, side view of a moldable, flame retardant acoustically absorbing fiber system, in accordance with yet other embodiments of the present invention. In FIG. 4, a moldable, flame retardant acoustically absorbing fiber system 400 is shown to include a nonwoven, moldable layer of a blend of fibers, including a needled layer of a mixture of fibers 410 including mainly about 50 to 90% generic shoddy-blend fibers (e.g., all cotton fibers, all polyester or other synthetic fibers or a mixture thereof) that have been saturated with a fire retardant chemical, about 5 to 25% low temperature PET bi-component binder fibers, and about 5 to 25% high temperature PET bi-component binder fibers. The activation temperatures of the binder fibers are the same as described above for FIG. 1. In general, the needled layer 410 has a weight of about 700 grams/m², an unmolded thickness of about 12 to 15 mm and a molded thickness of about 6 mm. The lower amount of each PET bi-component binder fiber reduces the overall stiffness of the product and reduces the amount of additional flame retardant that is needed for the product to meet the requirements of the UL 94 V-0 flame test. Applied to a first side of the unmolded, needled layer 410 is a first flame retardant coating 420, and applied to a second side of the unmolded, needled layer 410 is a second flame retardant coating 430. Each flame retardant coating 420, 430 penetrates about 2 to 3 mm into the unmolded, needled layer 410. A spun bond nonwoven black surface 440 is adhered to one side of the needled layer 410 with the flame retardant coating (e.g., the second flame retardant coating 430). The black surface 440 is water and oil resistant, acoustically transparent and can be adhered to the needled layer 410 and the second flame retardant coating 430 with a heat activated powdered adhesive 435, for example, a heat activated phenolic adhesive resin. The black surface 440 can be, for example, but not limited to, spun bond polyester Zetafelt G92/4298/70 K82 from Hof Textiles of Lincolnton, N.C. In general, the black surface 440 has a weight of about 85 to 90 grams/m² and a finished thickness of about 1 mm.

In FIG. 4, the first and second flame retardant layers 420, 430 together can add up to 15% by weight of the weight of the needled layer 410 or about 105 grams/m² and are substantially equal to each other in weight and depth of penetration into the needle layer 410. If no flame retardant coating is used, then the structure of the product is similar to that illustrated in FIG. 3. Therefore, the total weight of the fiber system ranges from about 785 to about 895 grams/m². The flame retardant coatings 420, 430 generally are applied one at a time using a roll coating process and then dried in an oven. Once both flame retardant layers 420, 430 are dried the black surface 440 can be adhered to the side of the needled layer 410 with the second flame retardant coating 430. The black surface 440 is considered the finished surface, so when the fiber system 400 is installed inside an engine valve cover, the black surface 440 is visible and faces the engine. The flame retardant coatings 420, 430 provide the non-burning properties so the entire system meets the UL 94 V-0 flame test and can be made of, for example, StarTex™ FR PE Conc. from StarChem of Wellford, S.C.

FIG. 5 is a cross-sectional, side view of a moldable, flame retardant acoustically absorbing fiber system, in accordance with still other embodiments of the present invention. In FIG. 5, a moldable, flame retardant acoustically absorbing fiber system 500 is shown to include a nonwoven, moldable layer of a blend of fibers, including a needled layer of a mixture of fibers 510 including mainly about 50 to 90% generic shoddy-blend fibers (e.g., all cotton fibers, all polyester or all other synthetic fibers or a mixture thereof), and about 10 to 50% thermoset powder-epoxy, for example, BANFLAME® FL-B40 from Ramcon-Fiberlok of Memphis, Tenn. The activation temperature for the thermoset powder-epoxy is 190 degrees C., which can be activated using a hot molding process and equipment. In general, the needled layer 510 has a weight of about 700 grams/m², an unmolded thickness of about 12 to 15 mm and a molded thickness of about 6 mm. Applied to a first side of the unmolded, needled layer 510 is a first flame retardant coating 520, and applied to a second side of the unmolded, needled layer 510 is a second flame retardant coating 530. Each flame retardant coating 520, 530 penetrates about 2 to 3 mm into the unmolded, needled layer 510. If no flame retardant coating is used, then the structure of the product is similar to that illustrated in FIG. 3. In FIG. 5, a spun bond nonwoven black surface 540 is adhered to one side of the needled layer 510 with the flame retardant coating (e.g., the second flame retardant coating 530). The black surface 540 is water and oil resistant, acoustically transparent and can be adhered to the needled layer 510 and the second flame retardant coating 530 with a heat activated powdered adhesive 535, for example, a heat activated phenolic adhesive resin. The black surface 540 is considered the finished surface, so when the fiber system 500 is installed inside an engine valve cover, the black surface 540 is visible and faces the engine. The black surface 540 can be, for example, but not limited to, spun bond polyester Zetafelt G92/4298/70 K82 from Hof Textiles of Lincolnton, N.C. In general, the black surface 540 has a weight of about 85 to 90 grams/m² and a finished thickness of about 1 mm.

In FIG. 5, the first and second flame retardant coatings 520, 530 together provide up to about 15% by weight of the weight of the needled layer 510 and are substantially equal to each other in weight and depth of penetration into the needled layer 510. For example, if the total weight of the needled layer 510 is 700 grams/m², the combined weight of the flame retardant coatings ranges up to about 105 grams/m². Therefore, the total weight of the active fiber system 500 ranges from about 785 to about 895 grams/m². The flame retardant coatings 520, 530 generally are applied one at a time using a roll coating process and then dried in the hot molding process. Once both coatings are dried the black layer 540 can be adhered to the needled layer 510 with the second flame retardant coating 530, which is the side that will be in contact with the engine. Each flame retardant coating 520, 530 meets the UL 94 V-0 flame test and can be made of, for example, StarTex™ FR PE Conc. from StarChem of Wellford, S.C.

In accordance with one or more embodiments of the present invention a moldable, flame retardant fiber system for acoustical absorption in a vehicle including a nonwoven, moldable layer of a blend of fibers, the moldable layer having opposite top and bottom sides; a flame retardant coating applied on both the top and bottom sides of the moldable layer to about 15% of a weight of the nonwoven, moldable layer of a blend of fibers; an adhesive layer; and a spun bond nonwoven black surface adhered to the flame retardant coating by the adhesive layer on one side of the nonwoven layer, the moldable, flame retardant fiber system configured to meet the UL 94 V-0 flame test.

In accordance with one or more embodiments of the present invention a moldable, flame retardant fiber system including a nonwoven moldable layer of a blend of fibers, including a mixture of fibers from flame retardant protective clothing and a two-part flame retardant polyethylene terephthalate (PET) bi-component binder fiber mixture, the moldable layer having opposite top and bottom sides; a flame retardant coating applied on both the top and bottom sides of the moldable layer to about 10% of a weight of the nonwoven, moldable layer of a blend of fibers; an adhesive layer; and a spun bond nonwoven black surface adhered to the flame retardant coating by the adhesive layer on one side of the nonwoven layer, the moldable, flame retardant fiber system configured to meet the UL 94 V-0 flame test.

In accordance with one or more embodiments of the present invention, a moldable, flame retardant fiber system including a nonwoven moldable layer of a blend of fibers, including a first portion of shoddy-blend fibers, a second portion of a low-temperature polyethylene terephthalate (PET) bi-component binder fiber, and a third portion of a high-temperature PET bi-component binder fiber, where the first portion is pretreated with a flame retardant; an adhesive; and a spun bond nonwoven black surface being adhered to one side of the nonwoven, moldable layer by the adhesive; the moldable flame retardant fiber system being configured to meet the UL 94 V-0 flame test.

In accordance with one or more embodiments of the present invention, a moldable, flame retardant fiber system including a nonwoven moldable layer of a blend of fibers, including a first portion of shoddy-blend fibers, a second portion of a low-temperature polyethylene terephthalate (PET) bi-component binder fiber, and a third portion of a high-temperature PET bi-component binder fiber, where each portion is pretreated with a flame retardant; an adhesive; and a spun bond nonwoven black surface being adhered to one side of the nonwoven, moldable layer by the adhesive; the moldable flame retardant fiber system being configured to meet the UL 94 V-0 flame test.

In accordance with one or more embodiments of the present invention, a moldable, flame retardant fiber system including a nonwoven moldable layer of a blend of fibers and a powder adhesive; and a spun bond nonwoven black surface being adhered to one side of the nonwoven, moldable layer by a second adhesive; the moldable flame retardant fiber system being configured to meet the UL 94 V-0 flame test.

While the present invention has been described in conjunction with a number of embodiments, the invention is not to be limited to the description of the embodiments contained herein. It is further evident that many alternatives, modifications, and variations would be or are apparent to those of ordinary skill in the applicable arts. Accordingly, all such alternatives, modifications, equivalents, and variations that are within the spirit and scope of this invention are included.

What is claimed is:

1. A moldable, flame retardant fiber system for acoustical absorption in a vehicle comprising:
a nonwoven, moldable layer of a blend of fibers, the moldable layer having opposite top and bottom sides;
a flame retardant coating applied on both the top and bottom sides of the moldable layer to about 15% of a weight of the nonwoven, moldable layer of a blend of fibers;
an adhesive layer; and
a spun bond nonwoven black surface adhered to the flame retardant coating by the adhesive layer on one side of the nonwoven layer,
the moldable, flame retardant fiber system configured to meet the UL 94 V-0 flame test.

2. The moldable, flame retardant fiber system of claim 1, wherein the moldable layer of the blend of fibers comprises:
a needled layer of the mixture of fibers including substantially mainly recycled fibers from protective clothing for emergency service personnel and fire fighters, low temperature polyethylene terephthalate (PET) bi-component binder fibers, and high temperature PET bi-component binder fibers, and the needled layer of the mixture of fibers has an unmolded thickness of about 12 to 15 mm.

3. The moldable, flame retardant fiber system of claim 2, wherein the substantially mainly recycled fibers from protective clothing for emergency service personnel and fire fighters comprises about 5% percent by weight of waste cotton fiber.

4. The moldable, flame retardant fiber system of claim 2, wherein the mixture of fibers containing substantially mainly fibers from protective clothing for emergency service personnel and fire fighters further are substantially mainly flame retardant aramid fibers.

5. The moldable, flame retardant fiber system of claim 1, wherein each of the flame retardant coatings penetrates about 2 to 3 mm in to each of the top and bottom sides of the nonwoven, moldable layer of the blend of fibers.

6. The moldable, flame retardant fiber system of claim 1, wherein the spun bond nonwoven black surface is acoustically transparent, oil and water repellant, and has a weight of about 85 to 90 grams/m².

7. The moldable, flame retardant fiber system of claim 1, wherein the spun bond nonwoven black surface is adhered to the one side of the nonwoven layer by a heat-activated, phenolic resin adhesive.

8. The moldable, flame retardant fiber system of claim 1, wherein the spun bond nonwoven black surface comprises spun bond polyester and wherein the spun bond nonwoven black surface is configured to meet the UL 94 V-0 flame test.

9. The moldable, flame retardant fiber system of claim 8, wherein the finished thickness of the spun bond nonwoven black surface is about 1 mm.

10. The moldable, flame retardant fiber system of claim 2, wherein the needled layer of the mixture of fibers comprises about 50% recycled fibers from protective clothing for emergency service personnel and fire fighters, about 25% low temperature PET bi-component binder fibers, and about 25% of the high temperature PET bi-component binder fibers.

11. The moldable, flame retardant fiber system of claim 10, wherein the about 50% recycled fibers includes about 5% by weight of waste cotton fibers.

12. The moldable, flame retardant fiber system of claim 10, wherein the low temperature PET bi-component binder fibers has an activation temperature of about 110 degrees C.

13. The moldable, flame retardant fiber system of claim 10, wherein the high temperature PET bi-component binder fibers has an activation temperature of about 180 degrees C.

14. A moldable, flame retardant fiber system comprising:
a nonwoven moldable layer of a blend of fibers, including a mixture of fibers from flame retardant protective clothing and a two-part flame retardant polyethylene terephthalate (PET) bi-component binder fiber mixture, the moldable layer having opposite top and bottom sides;
a flame retardant coating applied on both the top and bottom sides of the moldable layer to about 10% of a weight of the nonwoven, moldable layer of a blend of fibers;
an adhesive layer; and
a spun bond nonwoven black surface adhered to the flame retardant coating by the adhesive layer on one side of the nonwoven layer,
the moldable, flame retardant fiber system configured to meet the UL 94 V-0 flame test.

15. The moldable, flame retardant fiber system of claim 14 wherein the moldable layer of the blend of fibers comprises:
a needled layer of a mixture of fibers including about 60% substantially mainly recycled fibers from protective clothing for emergency service personnel and fire fighters, about 20% low temperature polyethylene terephthalate (PET) bi-component binder fibers, and about 20% high temperature PET bi-component binder fibers, and the needled layer of the mixture of fibers has an unmolded thickness of about 12 to 15 mm.

16. The moldable, flame retardant fiber system of claim 15, wherein the mixture of fibers including substantially mainly recycled fibers from protective clothing for emergency service personnel and fire fighters includes about 5% percent by weight of waste cotton fiber.

17. The moldable, flame retardant fiber system of claim 15, wherein the mixture of fibers containing substantially mainly fibers from protective clothing for emergency service personnel and fire fighters further are substantially mainly flame retardant aramid fibers.

18. The moldable, flame retardant fiber system of claim 14, wherein each of the flame retardant coatings penetrates about 2 to 3 mm in to each of the top and bottom sides of the nonwoven, moldable layer of the blend of fibers.

19. The moldable, flame retardant fiber system of claim 14, wherein the spun bond nonwoven black surface is acoustically transparent and oil and water repellant.

20. The moldable, flame retardant fiber system of claim 14, wherein the adhesive is a phenolic resin adhesive.

21. The moldable, flame retardant fiber system of claim 14, wherein the spun bond nonwoven black surface comprises spun bond polyester and wherein the spun bond nonwoven black surface is configured to meet the UL 94 V-0 flame test.

22. The moldable, flame retardant fiber system of claim 21, wherein the finished thickness of the spun bond nonwoven black surface is about 1 mm.

23. The moldable, flame retardant fiber system of claim 15, wherein the needled layer of the mixture of fibers has a molded thickness of about 6 mm.

24. The moldable, flame retardant fiber system of claim 15, wherein the low temperature PET bi-component binder fibers has an activation temperature of about 110 degrees C.

25. The moldable, flame retardant fiber system of claim 15, wherein the high temperature PET bi-component binder fibers has an activation temperature of about 180 degrees C.

26. The moldable, flame retardant fiber system of claim 14 wherein the moldable layer of the blend of fibers comprises:
a needled layer of a mixture of fibers including about 90% substantially mainly recycled fibers from protective clothing for emergency service personnel and fire fighters, about 5% low temperature polyethylene terephthalate (PET) bi-component binder fibers, and about 5% high temperature PET bi-component binder fibers, and the needled layer of the mixture of fibers has an unmolded thickness of about 12 to 15 mm.

27. A moldable, flame retardant fiber system comprising:
a nonwoven moldable layer of a blend of fibers, including a first portion of shoddy-blend fibers, a second portion of a low-temperature polyethylene terephthalate (PET) bi-component binder fiber, and a third portion of a high-temperature PET bi-component binder fiber, where the first portion is pretreated with a flame retardant;
an adhesive; and
a spun bond nonwoven black surface being adhered to one side of the nonwoven, moldable layer by the adhesive;
the moldable flame retardant fiber system being configured to meet the UL 94 V-0 flame test.

28. The moldable, flame retardant fiber system of claim 27 wherein the flame retardant is ammonium sulfate.

29. The moldable, flame retardant fiber system of claim 27 further comprises:
a first flame retardant coating on the side of the nonwoven moldable layer opposite the spun bond nonwoven black surface.

30. The moldable, flame retardant fiber system of claim 29 further comprises:
a second flame retardant coating between the spun bond nonwoven black surface and the unwoven moldable layer.

31. The moldable, flame retardant fiber system of claim 30 wherein the first and second flame retardant coatings comprise up to 15% by weight of the nonwoven, moldable layer.

32. The moldable, flame retardant fiber system of claim 31, wherein each of the flame retardant coatings penetrates about 2 to 3 mm in to each of the top and bottom sides of the nonwoven, moldable layer of the blend of fibers.

33. The moldable, flame retardant fiber system of claim 31 wherein the nonwoven moldable layer of a blend of fibers include about 50% of the first portion of shoddy-blend fibers, about 25% of the second portion of a low-temperature polyethylene terephthalate (PET) bi-component binder fiber, and about 25% of the third portion of a high-temperature PET bi-component binder fiber.

34. The moldable, flame retardant fiber system of claim 31 wherein the nonwoven moldable layer of a blend of fibers include about 90% of the first portion of shoddy-blend fibers, about 5% of the second portion of a low-temperature polyethylene terephthalate (PET) bi-component binder fiber, and about 5% of the third portion of a high-temperature PET bi-component binder fiber.

35. The moldable, flame retardant fiber system of claim 27, wherein the spun bond nonwoven black surface is acoustically transparent and oil and water repellant.

36. The moldable, flame retardant fiber system of claim 27, wherein the adhesive is a phenolic resin adhesive.

37. The moldable, flame retardant fiber system of claim 27, wherein the spun bond nonwoven black surface comprises spun bond polyester and wherein the spun bond nonwoven black surface is configured to meet the UL 94 V-0 flame test.

38. The moldable, flame retardant fiber system of claim 27, wherein the finished thickness of the spun bond nonwoven black surface is about 1 mm.

39. The moldable, flame retardant fiber system of claim 27, wherein the low temperature PET bi-component binder fibers has an activation temperature of about 110 degrees C.

40. The moldable, flame retardant fiber system of claim 27, wherein the high temperature PET bi-component binder fibers has an activation temperature of about 180 degrees C.

41. A moldable, flame retardant fiber system comprising:
a nonwoven moldable layer of a blend of fibers, including a first portion of shoddy-blend fibers, a second portion of a low-temperature polyethylene terephthalate (PET) bi-component binder fiber, and a third portion of a high-temperature PET bi-component binder fiber, where each portion is pretreated with a flame retardant;
an adhesive; and
a spun bond nonwoven black surface being adhered to one side of the nonwoven, moldable layer by the adhesive;
the moldable flame retardant fiber system being configured to meet the UL 94 V-0 flame test.

42. The moldable, flame retardant fiber system of claim 41 wherein the flame retardant is ammonium sulfate.

43. The moldable, flame retardant fiber system of claim 41 further comprises:
a first flame retardant coating on the side of the nonwoven moldable layer opposite the spun bond nonwoven black surface; and
a second flame retardant coating between the spun bond nonwoven black surface and the unwoven moldable layer.

44. The moldable, flame retardant fiber system of claim 43 wherein the first and second flame retardant coatings comprise up to 15% by weight of the nonwoven, moldable layer.

45. The moldable, flame retardant fiber system of claim 41 wherein the nonwoven moldable layer of a blend of fibers include about 50% of the first portion of shoddy-blend fibers, about 25% of the second portion of a low-temperature polyethylene terephthalate (PET) bi-component binder fiber, and about 25% of the third portion of a high-temperature PET bi-component binder fiber.

46. The moldable, flame retardant fiber system of claim 41 wherein the nonwoven moldable layer of a blend of fibers include about 90% of the first portion of shoddy-blend fibers, about 5% of the second portion of a low-temperature polyethylene terephthalate (PET) bi-component binder fiber, and about 5% of the third portion of a high-temperature PET bi-component binder fiber.

47. The moldable, flame retardant fiber system of claim 41, wherein the spun bond nonwoven black surface is acoustically transparent and oil and water repellant.

48. The moldable, flame retardant fiber system of claim 41, wherein the adhesive is a phenolic resin adhesive.

49. The moldable, flame retardant fiber system of claim 41, wherein the spun bond nonwoven black surface comprises spun bond polyester and wherein the spun bond nonwoven black surface is configured to meet the UL 94 V-0 flame test.

50. The moldable, flame retardant fiber system of claim 41, wherein the finished thickness of the spun bond nonwoven black surface is about 1 mm.

51. The moldable, flame retardant fiber system of claim 41, wherein the low temperature PET bi-component binder fibers has an activation temperature of about 110 degrees C.

52. The moldable, flame retardant fiber system of claim 41, wherein the high temperature PET bi-component binder fibers has an activation temperature of about 180 degrees C.

53. A moldable, flame retardant fiber system comprising:
a nonwoven moldable layer of a blend of fibers and a powder adhesive; and
a spun bond nonwoven black surface being adhered to one side of the nonwoven, moldable layer by a second adhesive;
the moldable flame retardant fiber system being configured to meet the UL 94 V-0 flame test.

54. The moldable, flame retardant fiber system of claim 53 wherein the blend of fibers comprises a shoddy-blend of fibers pretreated with a flame retardant.

55. The moldable, flame retardant fiber system of claim 54 wherein the flame retardant is ammonium sulfate.

56. The moldable, flame retardant fiber system of claim 53 wherein the blend of fibers and the powder adhesive comprises a needled layer of the mixture of fibers including substantially mainly recycled fibers from protective clothing for emergency service personnel and fire fighters, and a fiber-retardant powder epoxy, and the needled layer of the mixture of fibers and the fiber-retardant powder epoxy has an unmolded thickness of about 12 to 15 mm.

57. The moldable, flame retardant fiber system of claim 56, wherein the substantially mainly recycled fibers from protective clothing for emergency service personnel and fire fighters comprises about 5% percent by weight of waste cotton fiber.

58. The moldable, flame retardant fiber system of claim 53 further comprises:
a first flame retardant coating on the side of the nonwoven moldable layer opposite the spun bond nonwoven black surface; and
a second flame retardant coating between the spun bond nonwoven black surface and the unwoven moldable layer.

59. The moldable, flame retardant fiber system of claim 53 wherein the first and second flame retardant coatings comprise up to 15% by weight of the nonwoven, moldable layer.

60. The moldable, flame retardant fiber system of claim 54 wherein the nonwoven moldable layer of a blend of fibers include about 50% of the shoddy-blend of fibers pretreated with the flame retardant, and about 50% of the powder epoxy.

61. The moldable, flame retardant fiber system of claim 54 wherein the nonwoven moldable layer of a blend of fibers include about 90% of the shoddy-blend of fibers pretreated with the flame retardant, and about 10% of the powder epoxy.

62. The moldable, flame retardant fiber system of claim 53 wherein the nonwoven moldable layer of a blend of fibers include about 50% of the substantially mainly recycled fibers from protective clothing for emergency service personnel and fire fighters, and about 50% of the powder epoxy.

63. The moldable, flame retardant fiber system of claim 53 wherein the nonwoven moldable layer of a blend of fibers include about 90% of the substantially mainly recycled fibers from protective clothing for emergency service personnel and fire fighters, and about 10% of the powder epoxy.

64. The moldable, flame retardant fiber system of claim 53, wherein the spun bond nonwoven black surface is acoustically transparent and oil and water repellant.

65. The moldable, flame retardant fiber system of claim 53, wherein the adhesive is a phenolic resin adhesive.

66. The moldable, flame retardant fiber system of claim 53, wherein the spun bond nonwoven black surface comprises spun bond polyester and wherein the spun bond nonwoven black surface is configured to meet the UL 94 V-0 flame test.

67. The moldable, flame retardant fiber system of claim 53, wherein the finished thickness of the spun bond nonwoven black surface is about 1 mm.

68. The moldable, flame retardant fiber system of claim 53, wherein the low temperature PET bi-component binder fibers has an activation temperature of about 110 degrees C.

69. The moldable, flame retardant fiber system of claim 53, wherein the high temperature PET bi-component binder fibers has an activation temperature of about 180 degrees C.
